(19) United States
(12) Patent Application Publication
(10) Pub. No.: US 2023/0146153 A1
(43) Pub. Date: May 11, 2023

(54) DISPLAY PANEL AND DISPLAY DEVICE

(71) Applicant: TCL CHINA STAR OPTOELECTRONICS TECHNOLOGY CO., LTD., Shenzhen, Guangdong (CN)

(72) Inventor: Dongmei SHAO, Shenzhen, Guangdong (CN)

(21) Appl. No.: 16/969,336

(22) PCT Filed: May 7, 2020
(86) PCT No.: PCT/CN2020/088944

§ 371 Date: Aug. 12, 2020

(30) Foreign Application Priority Data
Mar. 16, 2020 (CN) 202010179665.9

(51) Int. Cl. G02F 1/1335; G02F 1/1337; G02F 1/1339

(52) U.S. Cl. CPC G02F 1/133512; G02F 1/133531; G02F 1/133723; G02F 1/1339

(57) ABSTRACT

The present disclosure provides a display panel and a display device. The display panel includes a first substrate layer, a second substrate layer, and a sealing layer disposed between the first substrate layer and the second substrate layer, wherein a black matrix is provided in the first substrate layer, and the sealing layer surrounds the black matrix.

### BACKGROUND OF INVENTION

### Field of Invention

The present disclosure relates to a field of display devices, in particular to a display panel and a display device.

### Description of Prior Art

With continuous development of display technology, liquid crystal display devices such as mobile phones and tablet computers are widely used in people's lives, providing great convenience for people to obtain text, pictures, and video information. The liquid crystal displays have gradually become one of the most rapidly developed display devices due to their lightness and thinness. In order to meet the needs of most of users, thicknesses of the liquid crystal display panels are getting thinner and thinner, and meanwhile, the display quality requirements of the liquid crystal display panel are becoming higher and higher.

As shown in FIG. 1, in the prior art, a sealing layer 130 is generally disposed around an edge of the light-transmitting region. However, due to the light-shielding requirement of the edge of the display panel 100, a black matrix usually extends to the edge of the panel. In a high-temperature and high-humidity reliability test, the black matrix in an existing display panel structure is easily eroded by water vapor, causing shedding or peeling phenomenon, due to its material characteristics, thus impacting reliability of the display panel.

### SUMMARY OF INVENTION

An object of the present disclosure is to provide a display panel and a display device to solve the problem of the prior art that the black matrix is easily eroded by water vapor, causing shedding or peeling phenomenon.

In order to achieve the above object, the present disclosure provides a display panel including a first substrate layer, a second substrate layer, and a sealing layer provided between the first substrate layer and the second substrate layer, wherein a black matrix is provided in the first substrate layer, and the sealing layer surrounds the black matrix.

Further, the sealing layer has a groove facing the first substrate layer, and an edge of the black matrix is disposed in the groove.

Further, the first substrate layer further includes: a first polarizer, disposed on a surface of the black matrix away from the sealing layer, and corresponding to the black matrix; and a light-shielding layer, disposed on the black matrix and surrounding the first polarizer.

Further, the display panel has a light-transmitting area and a light-shielding area surrounding the light-transmitting area, the light-shielding layer corresponds to the light-shielding area, and the black matrix corresponds to the light-transmitting area or extends from the light-transmitting area to an edge of the light-shielding area.

Further, the first substrate layer further includes: a first light-transmitting layer, disposed between the first polarizer and the black matrix; a conductive layer, covering the black matrix and the first light-transmitting layer; and a first alignment film, covering the conductive layer and the surface of the black matrix.

Further, a depth of the groove is less than or equal to a sum of a thickness of the black matrix, a thickness of the conductive layer, and a thickness of the first alignment film.

Further, the second substrate layer includes: a second light-transmitting layer; a second polarizer, disposed on a surface of the second light-transmitting layer; and a second alignment film, disposed on a surface of the second light-transmitting layer away from the second polarizer.

Further, the first light-transmitting layer is a transparent insulating substrate; material of the conductive layer includes indium tin oxide; and material of the first alignment film includes polyimide.

Further, the second light-transmitting layer is a transparent insulating substrate; and material of the second alignment film includes polyimide.

The present disclosure also provides a display device including the above-mentioned display panel.

Advantages of the present disclosure are that in a display panel and a display device of the present disclosure, an edge of a black matrix is embed into a sealing layer, to protect the black matrix by the sealing layer, thereby preventing it from being eroded by water vapor, such that reliability and stability of the display screen are improved. In addition, by providing a light-shielding layer to ensure light-shielding effect of a light-shielding area of the display panel without increasing a thickness of the display panel.

### BRIEF DESCRIPTION OF DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

FIG. 1 is a schematic diagram of a layered structure of a display panel in the prior art;

FIG. 2 is a schematic diagram of a layered structure of a display panel in an embodiment of the present disclosure;

FIG. 3 is a schematic diagram of a layered structure of a display panel in an embodiment of the present disclosure.

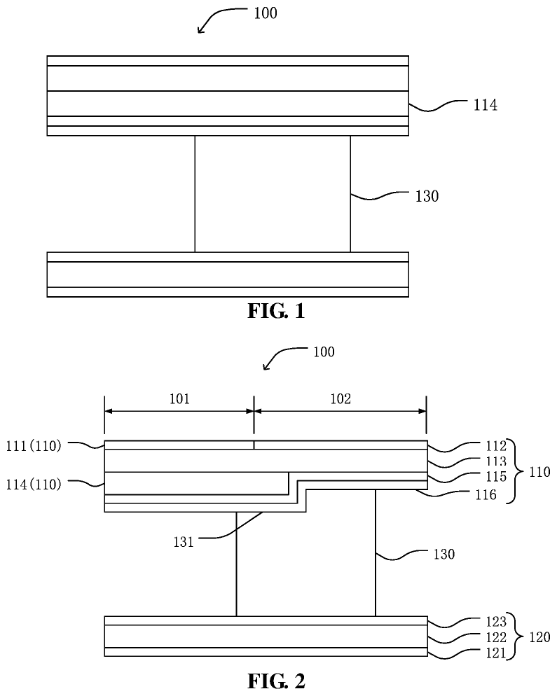

Elements in the drawings are designated by reference numerals listed below.
display panel 100;
light-transmitting area 101; light-shielding area 102;
first substrate layer 110; first polarizer 111;
light-shielding layer 112; first light-transmitting layer 113;
black matrix 114; conductive layer 115;
first alignment film 116; second substrate layer 120;
second polarizer 121; second light-transmitting layer 122;
second alignment film 123; sealing layer 130;
groove 131.

### DETAILED DESCRIPTION OF PREFERRED EMBODIMENTS

The preferred embodiments of the present invention are described below with reference to the accompanying drawings, which are configured to exemplify the embodiments of the present invention, which can fully describe the technical contents of the present invention to make the technical content of the present invention clearer and easy to understand. However, the present invention may be embodied in many different forms of embodiments, and the scope of the present invention is not limited to the embodiments set forth herein.

In the drawings, the spatially relative terms are intended to encompass different orientations in addition to the orientation as depicted in the figures. Moreover, the size and thickness of each component shown in the drawings are arbitrarily shown for ease of understanding and description, and the invention does not limit the size and thickness of each component. In order to make the illustration clearer, the thickness of components is exaggerated in some positions of the drawings.

The following description of the various embodiments is provided to illustrate the specific embodiments of the invention. Directional terminology mentioned in the present invention, such as “vertical”, “horizontal”, “upper”, “bottom”, “pre”, “post”, “left”, “right”, “inside”, “outside”, “side”, etc., only refer to the direction of the additional drawing. Therefore, the directional terminology is configured to better and more clearly explain and understand the present invention, rather than to indicate or imply that the device or element referred to must have a specific orientation, or must be constructed and operated in a specific orientation, and thus the directional terminology cannot be construed as limiting the present invention. In addition, the terms “first”, “second”, “third”, etc. are used for descriptive purposes only and should not be construed to indicate or imply relative importance.

When a component is described as “on” another component, the components are formed in direct contact, and may also include embodiments in which additional features may be formed interposing the first and second features, such that the first and second features may not be in direct contact. When a component is described as “installed to” or “connected to” another component, it can be understood that a component is “directly installed” or “directly connected” to another component, or a component is “installed to” or “connected with” another component through an intermediate component.

An embodiment of the present disclosure provides a display device having a display panel, which is a liquid crystal display panel and changes the transmittance of light by varying an angle of liquid crystal molecules, thereby realizing bright and dark display of an image for a display screen of the display device. The display device may be any electronic product or component with a display function, such as a mobile phone, a notebook computer, a television, and so on.

The display panel 100 is shown in FIG. 2. The display panel 100 has a light-transmitting area 101 and a light-shielding area 102 surrounding the light-transmitting area 101. The light-shielding area 102 is configured to prevent a frame of the display panel 100 from leaking light.

The display panel 100 includes a first substrate layer 110, a second substrate layer 120, and a sealing layer 130.

The first substrate layer 110 includes a first light-transmitting layer 113, a first polarizer 111, a black matrix 114, a conductive layer 115, a first alignment film 116, and a light-shielding layer 112.

The first light-transmitting layer 113 is an insulating substrate, such as a glass substrate or a quartz substrate.

The first polarizer 111 is disposed on a surface of the first light-transmitting layer 113. The light shielding layer 112 is provided in the same layer as the first polarizer 111, and the light shielding layer 112 surrounds the first polarizer 111. The first polarizer 111 corresponds to the light-transmitting area 101 of the display panel 100, and the light-shielding layer 112 corresponds to the light-shielding area 102 of the display panel 100. The first polarizer 111 is configured to analyze the polarized light that has been electrically modulated by liquid crystal in the display panel 100 to generate contrast between bright and dark, thereby generating a display screen. The light shielding layer 112 is configured to shield an edge of the display panel 100 to prevent light leakage which impacts the display effect.

The black matrix 114 is disposed on a surface of the first light-transmitting layer 113 away from the first polarizer 111 and extends from the light-transmitting area 101 of the display panel 100 to an edge of the light-shielding area 102. The black matrix 114 is configured to divide adjacent color resists in a color filter, and to shield color gaps, such that light leakage or color mixing can be prevented, thus ensuring the shielding effect of the color filter of three primary colors.

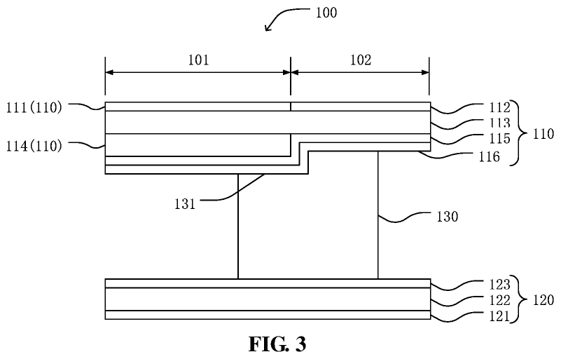

In other embodiments of the present disclosure, the black matrix 114 may also correspond to the light-transmitting area 101 as shown in FIG. 3, and has a layered structure similar to the display panel 100 provided in this embodiment, which is not detailed for brevity. Based on the embodiments in the present application, all other embodiments obtained by a person of ordinary skill in the art without making creative efforts fall within the protection scope of the present application.

The conductive layer 115 covers the black matrix 114 and the first transparent layer. The conductive layer 115 is an indium tin oxide transparent conductive film layer. The conductive layer 115 is configured to generate an electric field after being energized, and the electric field is controlled to change a deflection angle of the liquid crystal molecules in the display panel 100, thereby varying the light transmittance.

The first alignment film 116 covers a surface of the conductive layer 115 away from the black matrix 114. Material of the first alignment film 116 includes polyimide.

The second substrate layer 120 includes a second light-transmitting layer 122, a second polarizer 121 and a second alignment film 123.

The second light-transmitting layer 122 is an insulating substrate, such as a glass substrate or a quartz substrate.

The second polarizer 121 is disposed on a surface of the second light-transmitting layer 122. The second polarizer 121 is configured to convert a light beam generated by a backlight in the display device into polarized light.

The second alignment film 123 covers a surface of the second light-transmitting layer 122 away from the second polarizer 121. Material of the second alignment film 123 includes polyimide. Both the second alignment film 123 and the first alignment film 116 in the first substrate layer 110 are configured to make the liquid crystal molecules restored to their original arrangement angle after the electric field is turned off.

The sealing layer 130 is disposed between the first substrate layer 110 and the second substrate layer 120, and the sealing layer 130 is provided with a groove 131, wherein an edge of the black matrix 114 covering the black matrix, part of the conductive layer 115 expected to cover the black matrix 114, and the first alignment film 116 are all disposed in the groove 131. A depth of the groove 131 is less than or equal to a sum of a thickness of the black matrix 114, a thickness of the conductive layer 115, and a thickness of the first alignment film 116. The sealing layer 130 is configured to bond the first substrate layer 110 and the second substrate layer 120, and meanwhile wrap the edge of the black matrix 114 in the sealing layer 130 to prevent the black matrix 114 from peeling off due to the intrusion of water vapor.

In the display panel 100 and the display device provided in the embodiments of the present disclosure, the edge of the black matrix 114 is embed into the sealing layer 130, to protect the black matrix 114 by the sealing layer, thereby preventing it from being eroded by water vapor, such that reliability and stability of the display screen are improved. In addition, by providing the light-shielding layer 112 on the edge of the first polarizer 111, to ensure light-shielding effect of a light-shielding area 102 of the display panel 100 without increasing a thickness of the display panel 100.

Although the present invention is described herein with reference to specific embodiments, it should be understood that these embodiments are merely examples of the principles and applications of the present invention. It should therefore be understood that many modifications can be made to the exemplary embodiments and other arrangements can be devised without departing from the spirit and scope of the invention as defined by the appended claims. Further, it should be understood that different dependent claims and features described herein may be combined in a manner different from that described in the original claims. It can also be understood that combinations between features described in separate embodiments may be used in other described embodiments.

What is claimed is:

1. A display panel, comprising a first substrate layer, a second substrate layer, and a sealing layer provided between the first substrate layer and the second substrate layer,
wherein a black matrix is provided in the first substrate layer, and the sealing layer surrounds the black matrix.

2. The display panel according to claim 1, wherein the sealing layer has a groove facing the first substrate layer, and an edge of the black matrix is disposed in the groove.

3. The display panel according to claim 2, wherein the first substrate layer further comprises:
a first polarizer, disposed on a surface of the black matrix away from the sealing layer, and corresponding to the black matrix; and
a light-shielding layer, disposed on the black matrix and surrounding the first polarizer.

4. The display panel according to claim 3, wherein the display panel has a light-transmitting area and a light-shielding area surrounding the light-transmitting area, the light-shielding layer corresponds to the light-shielding area, and the black matrix corresponds to the light-transmitting area or extends from the light-transmitting area to an edge of the light-shielding area.

5. The display panel according to claim 3, wherein the first substrate layer further comprises:
a first light-transmitting layer, disposed between the first polarizer and the black matrix;
a conductive layer, covering the black matrix and the first light-transmitting layer; and
a first alignment film, covering the conductive layer and the surface of the black matrix.

6. The display panel according to claim 5, wherein a depth of the groove is less than or equal to a sum of a thickness of the black matrix, a thickness of the conductive layer, and a thickness of the first alignment film.

7. The display panel according to claim 1, wherein the second substrate layer comprises:
a second light-transmitting layer;
a second polarizer, disposed on a surface of the second light-transmitting layer; and
a second alignment film, disposed on a surface of the second light-transmitting layer away from the second polarizer.

8. The display panel according to claim 1, wherein
the first light-transmitting layer is a transparent insulating substrate;
material of the conductive layer comprises indium tin oxide; and
material of the first alignment film comprises polyimide.

9. The display panel according to claim 7, wherein
the second light-transmitting layer is a transparent insulating substrate; and
material of the second alignment film comprises polyimide.

10. A display device, comprising the display panel according to claim 1.
